(19) United States
(12) Patent Application Publication
(10) Pub. No.: US 2007/0199300 A1
(43) Pub. Date: Aug. 30, 2007

(54) Hybrid oxy-fuel combustion power process

(76) Inventors: Scott MacAdam, El Dorado Hills, CA (US); Lawrence C. Hoffman, Citrus Heights, CA (US); Fermin Viteri, Sacramento, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 11/709,594

(22) Filed: Feb. 21, 2007

Related U.S. Application Data
(60) Provisional application No. 60/775,491, filed on Feb. 21, 2006.

(51) Int. Cl. F02C 3/30

(52) U.S. Cl. 60/39.52; 60/39.55

(57) ABSTRACT

A closed loop oxy-fuel combustion power generation cycle is disclosed. The closed cycle has a gas generator which combusts oxygen with a hydrocarbon fuel to produce a drive gas mixture of steam and carbon dioxide that drives a turbine directly with the drive gas mixture. The drive gas mixture then enters a condenser where carbon dioxide is removed and water is recirculated to a heat exchanger where heat is transferred from the drive gas mixture to the water, to produce high pressure steam. This high pressure steam acts as a separate drive gas for a steam turbine. This steam is only indirectly heated by the gas generator through the heat exchanger, such that the cycle includes both direct and indirect heating of working fluids. Water/steam downstream from the steam turbine is then routed back to the gas generator or downstream of the gas generator to close the cycle.

### CROSS-REFERENCE TO RELATED APPLICATIONS

This application claims benefit under Title 35, United States Code §119(e) of U.S. Provisional Application No. 60/775,491 filed on Feb. 21, 2006.

### STATEMENT REGARDING FEDERALLY SPONSORED RESEARCH OR DEVELOPMENT

This invention was made with Government support under Collaborative Research Agreement No. DE-FC26-05NT42465 awarded by the Department of Energy. The Government has certain rights in this invention.

### FIELD OF THE INVENTION

The following invention relates to processes and systems for power generation through combustion of a hydrocarbon fuel with oxygen, such that emissions are reduced or eliminated. More particularly, this invention relates to oxy-fuel combustion power generation systems which have at least two separate expanders with each of the two expanders driven by a unique drive gas, one of the drive gases being substantially pure steam and the other drive gas being a mixture of steam and carbon dioxide.

### BACKGROUND OF THE INVENTION

Oxy-fuel combustion power generation systems are disclosed in the prior art for generation of power from a hydrocarbon fuel with substantially pure oxygen, such that products of combustion are substantially limited to only steam and carbon dioxide, and emissions can be reduced or eliminated. For instance, such oxy-fuel combustion power generation systems are described in U.S. Pat. Nos. 5,956,937; 6,598,398; 6,637,183; 6,945,029; and 7,021,063, incorporated herein by reference in their entirety.

One important component of such oxy-fuel combustion power generation systems is a gas generator for combusting the hydrocarbon fuel with substantially pure oxygen to produce the drive gas mixture of substantially pure steam and carbon dioxide. Such gas generators are described in detail in U.S. Pat. Nos. 5,956,937 and 6,598,398, as well as U.S. Pat. No. 6,206,684, incorporated herein by reference in its entirety.

While such oxy-fuel combustion power generation systems are known to take on a variety of different configurations, a basic arrangement consistent with most embodiments of prior art oxy-fuel combustion power generation systems is limited to turbines or other expanders driven by the drive gas mixture of steam and carbon dioxide. Also, known prior art oxy-fuel combustion power generation systems are either described as operating as open cycles or returning water downstream from a condenser that returns only a water portion of the drive gas mixture back to the gas generator, to form an at least partially closed Rankine cycle power generation system. When this cycle is closed, the return line for the water is known to include pumps and feedwater heaters to beneficially increase the pressure and temperature of the water/steam before it is reintroduced into the gas generator. However, known prior art oxy-fuel combustion power generation systems have not included any turbines or other expanders on this substantially pure water/steam return line passing from the condenser to the gas generator.

In some prior art oxy-fuel combustion power generation systems, it is known to include a “bottoming cycle” in the form of an entirely separate Rankine cycle which can either have a pure steam working fluid or a working fluid mixture of steam and carbon dioxide. In such known oxy-fuel combustion power generation systems with a bottoming cycle, at least a portion of heating of the working fluid in the bottoming cycle occurs within a heat recovery steam generator (HRSG) or other heat exchanger. Because the working fluid is substantially pure steam in the bottoming cycle, this bottoming cycle is maintained as a separate circuit from the open or partially closed Rankine cycle operating on the drive gas mixture of steam and carbon dioxide produced by the gas generator in the primary cycle, to which the bottoming cycle is associated by heat transfer only.

To maximize power generation efficiency, expanders for drive gases are typically in the form of turbines operating at maximum attainable temperatures and pressures, defined by the state of the art. Such complex machinery is best operated with working fluids and inlet temperatures, pressures and flow rates as close to the design criteria for these turbines as possible. Turbine development has generally been divided into two separate forms including gas turbines and steam turbines. State of the art steam turbines have exceptionally high pressures, as high as 2,400 psia (or higher, such as with super critical steam turbines). State of the art gas turbines have been developed which operate at exceptionally high temperatures (as high as 2,600° F., or higher). However, maximum performance steam turbines have a relatively only moderately high inlet temperature of 1,000° F. to 1,300° F. Similarly, gas turbines have been developed with only moderately high pressures of perhaps up to 1,000 psia. Because gas generators in oxy-fuel combustion power generation systems produce an exceptionally high temperature and pressure drive gas mixture (up to 3,000° F. or higher and up to 1,500 psia and higher) due to the utilization of substantially pure oxygen as the oxidizer of the hydrocarbon fuel, the prior art steam and gas turbines do not take full advantage of the high temperature (and pressure) oxy-fuel combustion drive gas.

Such a high temperature high pressure drive gas working fluid comprised of a mixture of steam and carbon dioxide is not suited to the inlet conditions and drive gas characteristics of prior art turbines. Hence, prior art oxy-fuel combustion power generation systems have required dilution of the drive gas with extra water, or other diluent to provide the drive gas at temperatures which prior art turbines can be received. Accordingly, a need exists for an oxy-fuel combustion power generation system which can utilize both high efficiency gas turbines (for high temperature portions of the cycle) and steam turbines (for high pressure portions of the cycle) within a single hybrid cycle power generation system, such that power generation efficiency is maximized along with the low or zero emissions benefits of oxy-fuel combustion.

### SUMMARY OF THE INVENTION

With this invention a power generation system is provided which utilizes oxy-fuel combustion within a hybrid cycle that combines both gas turbines and steam turbines within a common cycle to maximize the beneficial attributes of both gas turbines and steam turbines while also providing the potential for zero emissions inherent in oxy-fuel combustion power generation systems.

In particular, the hybrid cycle includes a gas generator which combusts oxygen with a hydrocarbon fuel to produce products of combustion in the form of a drive gas mixture of substantially only steam and carbon dioxide. This drive gas mixture is fed to a drive gas turbine where this drive gas mixture is expanded and power is generated. Preferably, this drive gas mixture is supplied at medium pressure but high temperature (on the order of 300 psia and 2,600° F.). Such inlet conditions are known for prior art gas turbines, which typically include some form of blade cooling to accommodate the high temperatures at the turbine inlet.

The drive gas mixture is then passed through a heat exchanger where the drive gas mixture is cooled. The drive gas mixture can optionally be routed through a low pressure drive gas turbine to extract further power from the drive gas mixture. The drive gas mixture can thereafter optionally be routed through a feedwater heater where further cooling of the drive gas mixture takes place. This drive gas mixture would then typically be routed to a condenser or other separator where the drive gas mixture is cooled to the point where the water within the drive gas mixture condenses into a liquid, and carbon dioxide within the drive gas mixture remains a gas. The water is then easily separated and preferably at least a portion of this water is further utilized within the hybrid cycle while excess water can be removed from the system.

This water discharged from the condenser provides a second working fluid within the hybrid cycle. Specifically, the water is routed through at least one pump to pump the water up to a high pressure, optionally routed through the optional feedwater heater for heating of the water and then routed through the heat exchanger, where heat taken from the drive gas mixture elevates a temperature of the high pressure water/steam to a moderately high temperature. For instance, the steam gas might typically be pressurized to 2,400 psia and heated to 1,300° F.

A prior art steam turbine known to be utilized with a pure steam working fluid at such high pressure and intermediate temperature is then utilized to expand the pure stream working fluid and output additional power. The expanded steam with reduced pressure and temperature is then merged back into the hybrid cycle by addition to the drive gas mixture. Such recirculation of the water can occur within the gas generator or downstream from the gas generator. The resulting hybrid cycle is provided with two unique drive gases and with at least two turbines, at least one of which is driven by the drive gas mixture of substantially only steam and carbon dioxide and the other of which is driven by a substantially pure steam working fluid, both within a single at least partially closed hybrid cycle.

Variations on this basic hybrid cycle include bypass lines to route water downstream from the condenser directly back to the gas generator so that at least a portion of the water bypasses the steam turbine. Also, the hybrid cycle could feature more than one steam turbine, such as with one steam turbine expanding high pressure steam when routing it to the gas generator or downstream of the gas generator for mixture with the drive gas mixture. A second steam turbine can be provided feeding a separate condenser before routing the water discharged from the condenser back to the gas generator (after pumping to an inlet pressure for the gas generator) or routing the liquid water back to the heat exchanger for further heating and re-expansion of the water working fluid.

### OBJECTS OF THE INVENTION

Accordingly, a primary object of the present invention is to provide a power generation system which combusts a hydrocarbon fuel and provides low or zero atmospheric emissions.

Another object of the present invention is to provide a power generation system which has low or zero emissions and relatively high thermal efficiency for low cost operation.

Another object of the present invention is to provide a power generation system with two separate working fluids driving at least two separate expanders, with each driven by energy input by a common oxy-fuel combustion gas generator.

Another object of the present invention is to provide a power generation system with a gas turbine and a steam turbine within a single cycle.

Other further objects of the present invention will become apparent from a careful reading of the included drawing figures, the claims and detailed description of the invention.

### BRIEF DESCRIPTION OF THE DRAWINGS

FIG. 1 is a schematic of a basic hybrid cycle according to this invention. The pathways shown in broken lines represent alternative configurations therein.

FIG. 2 is a schematic of a modified hybrid cycle and including typical pressures and temperatures for this particular embodiment of the hybrid cycle.

FIG. 3 is a schematic of an additional alternative embodiment of the hybrid cycle including multiple steam turbines and multiple condensers therein.

### DESCRIPTION OF THE PREFERRED EMBODIMENT

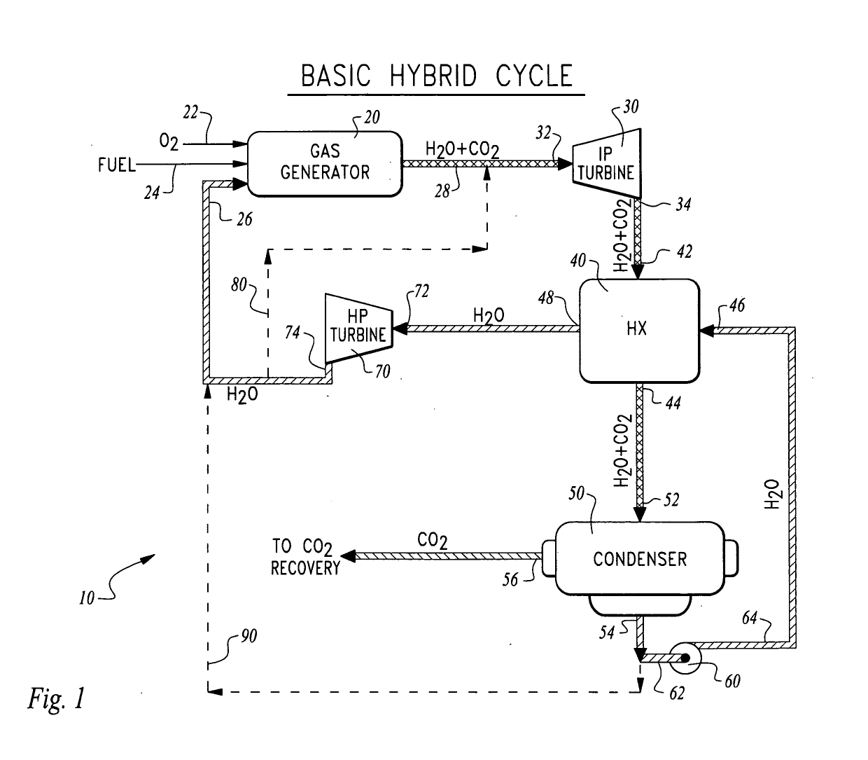

Referring to the drawings, wherein like reference numerals represent like parts throughout the various drawing figures, reference numeral 10 is directed to a hybrid cycle (FIG. 1) oxy-fuel combustion power generation system according to a most basic exemplary embodiment. With this hybrid cycle 10, two separate working fluids are included within a single cycle with the first of the working fluids being a drive gas mixture of steam and carbon dioxide and a second substantially pure water/steam working fluid.

Each of the drive gases drives a separate turbine 30, 70. In this way, the hybrid cycle is neither a purely direct cycle with all of the turbines or other expanders driven by exhaust from the gas generator 20 directly, nor is it an indirect cycle in that all of the turbines are driven by a drive gas heated through heat exchangers from the exhaust of the gas generator 20. Rather, one of the turbines is directly driven by the exhaust from the gas generator 20 while the other turbine is driven by a working fluid (steam) that is indirectly heated through a heat exchanger by heat originally generated within the gas generator 20. Thus, oxy-fuel combustion power generation is provided in a combined direct and indirect fashion with two distinct working fluids, termed a “hybrid cycle” 10.

In essence, and with particular reference to FIG. 1, general details of the basic hybrid cycle 10 are described. Initially, the gas generator 20 is provided for combustion of oxygen with a hydrocarbon fuel to produce a drive gas mixture of substantially only water/steam and carbon dioxide. This drive gas mixture is depicted in FIG. 1 with positive and negative slope cross-hatching (“ . . . XXX . . . ”) to illustrate the drive gas' two compound nature. This drive gas mixture is fed to a drive gas turbine 30 at relatively high temperature and only moderately high pressure. The turbine 30 is thus termed an intermediate pressure (IP) turbine 30. The expanded drive gas mixture is then routed from the IP turbine 30 to a heat exchanger 40. The drive gas mixture is cooled within the heat exchanger 40 and is then routed to a condenser 50.

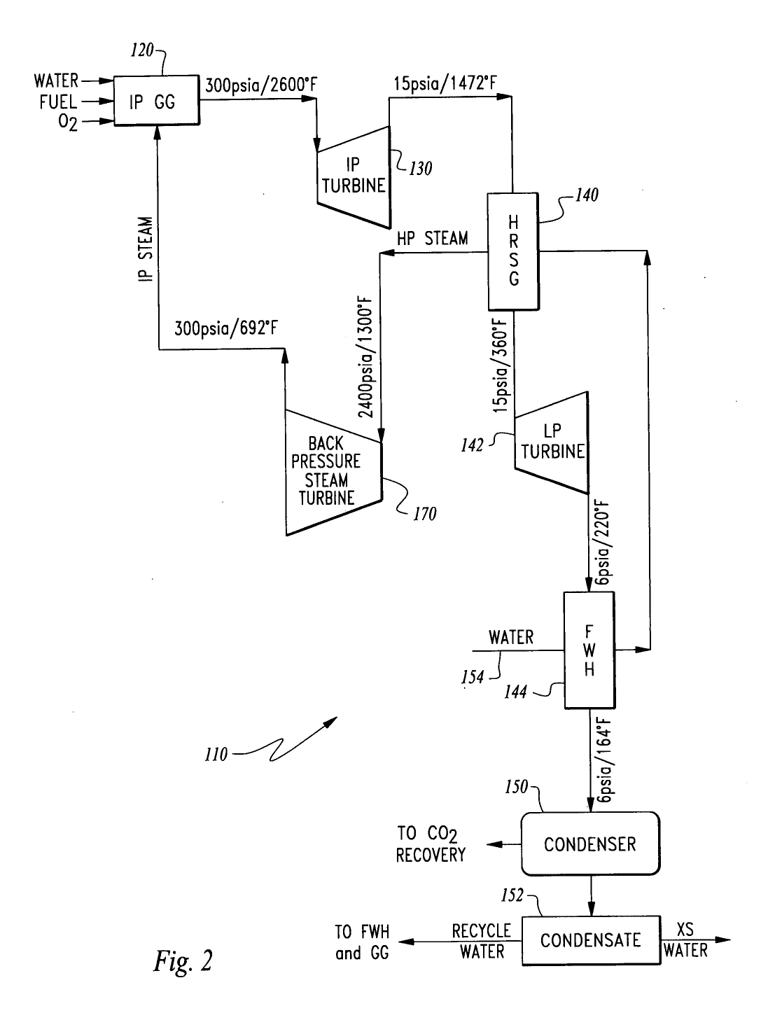

Within the condenser 50, the drive gas mixture is further cooled to cause water within the drive gas mixture to condense into a liquid. A gas outlet 56 removes carbon dioxide (CO2) and any other gases from the condenser 50 for recovery of the CO2 and sequestration of the CO2 away from the atmosphere, such that no atmospheric emissions result. The CO2 is depicted in FIG. 2 with only negative slope cross-hatching (“ . . . \\\ . . . ”) to indicate its substantially single compound nature.

Water exiting the condenser 50 through a liquid outlet 54 is at least partially routed to a pump 60 where the substantially pure water is pumped to a high pressure. The water is depicted in FIG. 2 with only positive slope cross-hatching (“ . . . /// . . . ”) to indicate its substantially single compound nature, but distinct from the CO2. This high pressure water is then routed through the heat exchanger 40 where it is caused to be heated with heat from the drive gas mixture. The heat exchanger 40 thus heats the high pressure water/steam while cooling the lower pressure drive gas mixture of steam and carbon dioxide. The steam leaves the heat exchanger 40 as a high pressure and moderately high temperature second working fluid for the hybrid cycle 10. This steam is routed to a steam turbine 70 or other water expander, termed a high pressure (HP) turbine and further power is outputted from the hybrid cycle 10.

The water discharged from the HP turbine 70 is then returned to the cycle. In particular, the water is preferably routed back to the gas generator 20 where it is injected along with fuel and oxygen and the water moderates temperature of oxy-fuel combustion by acting as a diluent within the gas generator 20. Optionally, as an alternative or in addition to such return of water to the gas generator 20, the water/steam discharged from the HP turbine 70 can be routed along a gas generator bypass 80 directly to be mixed at a drive gas junction with the drive gas mixture of steam and carbon dioxide upstream of the IP turbine 30. Also, at least a portion of the water at the liquid outlet 54 of the condenser 50 can optionally be routed along a HP turbine bypass 90 directly back to a water inlet 26 of the gas generator 20.

More specifically, and with continuing reference to FIG. 1, specific details of the basic hybrid cycle 10 are described. The gas generator 20 is any form of oxy-fuel combustor adapted to combust substantially pure oxygen with a hydrocarbon fuel. Most preferably, this oxygen is supplied from an oxygen source through an oxygen inlet 22 into the gas generator 20. The oxygen source can be an air separation unit or other source of oxygen. When the oxygen is supplied from an air separation unit, the oxygen would typically also include at least trace portions of other gases, and most typically as much as a few percent argon. As argon is a generally inert gas, it can be allowed to flow through the entire system.

The gas generator 20 is also coupled to a source of hydrocarbon fuel through a fuel inlet 24. This source of hydrocarbon fuel can be any fuel including both hydrogen and carbon containing molecules. For instance, the fuel could be natural gas, pure methane, or larger molecule hydrogen and carbon compounds, or could include light alcohols or other oxygenated hydrocarbon fuels. The hydrocarbon fuel could be a mixture of separate hydrogen and carbon containing compounds, such as a synthetic gas of hydrogen molecules and carbon monoxide molecules, such as are produced within coal gasification units or other equipment which gasifies a liquid or solid fuel.

The hydrocarbon fuel could also be a liquid fuel. In the case where the fuel is a liquid fuel, the fuel could be introduced exclusively through the fuel inlet 24 or the fuel inlet 24 and water inlet 26 could at least to some extent be combined. Gas generators 20 suitable for utilization in the hybrid cycle 10 are provided by Clean Energy Systems, Inc. of Rancho Cordova, Calif.

The gas generator 20 produces a drive gas mixture of substantially only steam and carbon dioxide discharged from the gas generator 20 at an outlet 28. This drive gas mixture could include excess oxygen if desired, such as to make sure that a combustion reaction between the hydrocarbon fuel and the oxygen is driven to completion, or to supply oxygen for support of further combustion reactions, such as in a reheater that might be supplied downstream of the gas generator 20.

The drive gas mixture is then routed to the drive gas turbine 30 (referred to as the “IP turbine” due to its inlet pressure less than that of the turbine 70) and enters the IP turbine 30 through an input 32. The drive gas mixture preferably has a high temperature and only moderate pressure, with typical temperature and pressure being 2,600° F. and 300 psia. The IP turbine 30 could be any appropriate expander, but is most preferably generally in the form of a gas turbine. The IP turbine 30 can output power by driving an electric generator or by outputting mechanical shaft power. This outputted power could be released from the system such as to the electric grid, or could be utilized within the power plant, such as to drive pumps or an air separation unit providing oxygen for the gas generator 20.

The IP turbine 30 would typically employ blade cooling to facilitate operation at these high temperatures. Such blade cooling could be in the form of regenerative cooling or transpiration cooling. The drive gas mixture then passes to an output 34 of the IP turbine 30.

A heat exchanger 40 is provided downstream of the IP turbine 30. The drive gas mixture enters the heat exchanger 40 through a low pressure intake 42. The drive gas mixture is then cooled within the heat exchanger 40 by giving heat to a high pressure second working fluid (water) described in detail below. The drive gas mixture exits the heat exchanger 40 through a low pressure discharge 44. The drive gas mixture is then routed to a condenser 50.

The condenser 50 provides a preferred form of separator for separating the water/steam component of the drive gas mixture at least partially from the carbon dioxide component of the drive gas mixture. The condenser 50 cools the drive gas mixture to a temperature at which the water condenses into a liquid, with the carbon dioxide remaining as a gas. The condenser 50 includes an entry 52 for the drive gas mixture as well as a liquid outlet 54 and a gas outlet 56. The liquid outlet 54 provides for discharge of substantially pure water from the condenser 50. The gas outlet 56 provides an outlet for primarily carbon dioxide. Any other gases within the drive gas mixture would also leave the condenser 50 through the gas outlet 56. For instance, if argon was included with the oxygen entering the gas generator 20, this argon would also leave the condenser 50 through the gas outlet 56.

Because the gas outlet 56 is primarily carbon dioxide, the volume of gas discharged from the hybrid cycle 10 is relatively low compared to that of an air fired hydrocarbon combustion power generation plant, which requires a large smokestack with high volumes of oxygen depleted air including carbon dioxide and other gaseous pollutants therein. With the hybrid cycle 10, a relatively much smaller gas component is discharged from the condenser 50. Thus, not only is a lesser amount of gas required to be disposed of or beneficially used, but this gas discharge is largely CO2 and thus can be beneficially used where CO2 is desired. For instance, the CO2 can be pressurized and pumped into depleted oil wells to enhance oil recovery from such oil wells. Other alternatives include commercial use of the CO2 or sequestration of the CO2 in solid, liquid or gaseous form separate from the atmosphere. Greenhouse gas emissions to the atmosphere can thus be eliminated.

The water exiting the condenser 50 at the liquid outlet 54 is then routed back to the gas generator 20 or otherwise used within the hybrid cycle 10. However, the water is typically in quantities greater than that able to be beneficially used by the gas generator 20 or other portions of the hybrid cycle 10. Thus, at least some excess water is typically discharged from the hybrid cycle 10. The water to be recirculated is typically first pressurized to a very high pressure, such as 2,400 psia. Such pressurization would occur at the pump 60, by passing from the inlet 62 of the pump 60 to the outlet 64 of the pump 60. The high pressure water is then fed to the high pressure intake 46 of the heat exchanger 40 where the high pressure water is then heated with heat from the drive gas mixture entering the heat exchanger 40 at the low pressure intake 42, discussed in detail above.

The high pressure water is heated and vaporized into steam within the heat exchanger 40 and leaves the heat exchanger 40 as steam at the high pressure discharge 48. The high pressure water/steam leaves the heat exchanger 40 with a high pressure and moderately high temperature, such as typically 2,400 psia and 1,300° F. The water is now in a gaseous state and ready to function as a drive gas working fluid for a steam turbine. In particular, the steam drive gas is supplied to the HP turbine 70 through an input 72.

The HP turbine 70 expands the substantially pure steam to a lower pressure and temperature before discharge at an output 74. The HP turbine 70 could be any form of expander and also outputs power. The water/steam is then returned to the gas generator 20 through the water inlet 26. Optionally, the water can bypass the gas generator 20 by passing along a gas generator bypass 80 and joining the drive gas mixture at a drive gas junction between the gas generator 20 and the IP turbine 30. The bypass 80 provides one form of a means to return water to a location upstream of the drive gas turbine in the form of the IP turbine 30. Alternatively, the water can be routed to the gas generator 20 through the water inlet 26. The hybrid cycle 10 can alternatively have at least a portion of the water discharged from the condenser 50 routed directly back to the gas generator 20 along a high pressure turbine bypass 90.

With particular reference to FIG. 2, details of an alternative embodiment of the hybrid cycle 10 is described. This second embodiment of FIG. 2 is referred to as a modified hybrid cycle 110. This modified hybrid cycle 110 is generally similar to the hybrid cycle 10 in that it includes a gas generator 120, IP turbine 130, heat exchanger in the form of a heat recovery steam generator (HRSG) 140, a condenser 150 and a steam turbine 170, termed in this cycle a “back pressure steam turbine” 170. Uniquely, the modified hybrid cycle 110 of FIG. 2 includes exemplary pressure and temperature data for the two working fluids at important points along the hybrid cycle drive gas pathways.

Details of this modified hybrid cycle 110 are only described to the extent that they differ from the hybrid cycle 10 of FIG. 1 described in detail above. The gas generator 120 is termed an IP GG in that it is an intermediate pressure gas generator. Specifically, while oxy-fuel combustion gas generators can be operated at pressures as high as 1,500 psia (or higher), in this embodiment it is only required that the gas generator 20 operate to provide a drive gas mixture at 300 psia to match the inlet pressure of the IP turbine 130. Pumping requirements for the oxygen, hydrocarbon fuel and diluent water are correspondingly reduced. The IP gas generator 120 is shown as having both a water inlet and intermediate pressure steam inlet. In fact, these two inlets could be combined or separate. Also, in the case where the fuel is a liquid fuel or a gaseous fuel able to be effectively placed in a liquid state, it is conceivable that the fuel could be at least partially combined with the water.

The HRSG 140 is generally similar to the heat exchanger 40. It is referred to in the modified hybrid cycle 110 as a heat recovery steam generator 140 to indicate its similarity to heat recovery steam generators in indirect oxy-fuel combustion power generation systems where a drive gas mixture of steam and carbon dioxide is used to heat a different working fluid, such as a pure steam working fluid within a separate bottoming cycle. In this modified hybrid cycle 110, the separate working fluid is not within a separate cycle and is not an entirely separate working fluid. Rather, a single cycle is provided which has a routing which causes heat to be transferred from one portion of the single cycle to another portion of a single cycle and with separate portions of this single cycle having different working fluids, depending on which side of the gas generator 120 and which side of the condenser 150 that the overall hybrid cycle 110 is viewed. Downstream of the HRSG 140, the modified hybrid cycle 110 includes a low pressure (LP) turbine 142 as a preferred form of second drive gas turbine or other expander for further expanding and power output from the cycle 110. The drive gas mixture is then passed on to a feedwater heater where the drive gas mixture is further cooled. The drive gas mixture is finally routed to the condenser 150 similar to the condenser 50 of the hybrid cycle 10.

Condensate in the form of water is handled at 152 either as excess water and removed from the system or recycled. Such recycling can either be directed to the gas generator, akin to the HP turbine bypass 90 (FIG. 1) or can be routed to the feedwater heater 144 along water inlet 154. This water inlet 154 provides the water (typically after pressurization) to a high pressure through the feedwater heater 144 for initial heating. The water is then further heated within the HRSG 140 to be provided as high pressure and moderately high temperature steam. In particular, the high pressure steam would typically have a pressure and a temperature of for instance 2,400 psia and 1,300° F. The back pressure steam turbine 170 then expands the high pressure steam to a lower pressure, such as 300 psia and 692° F. In this modified hybrid cycle 110, the water/steam is then returned to the gas generator 120 to close the overall modified hybrid cycle 110.

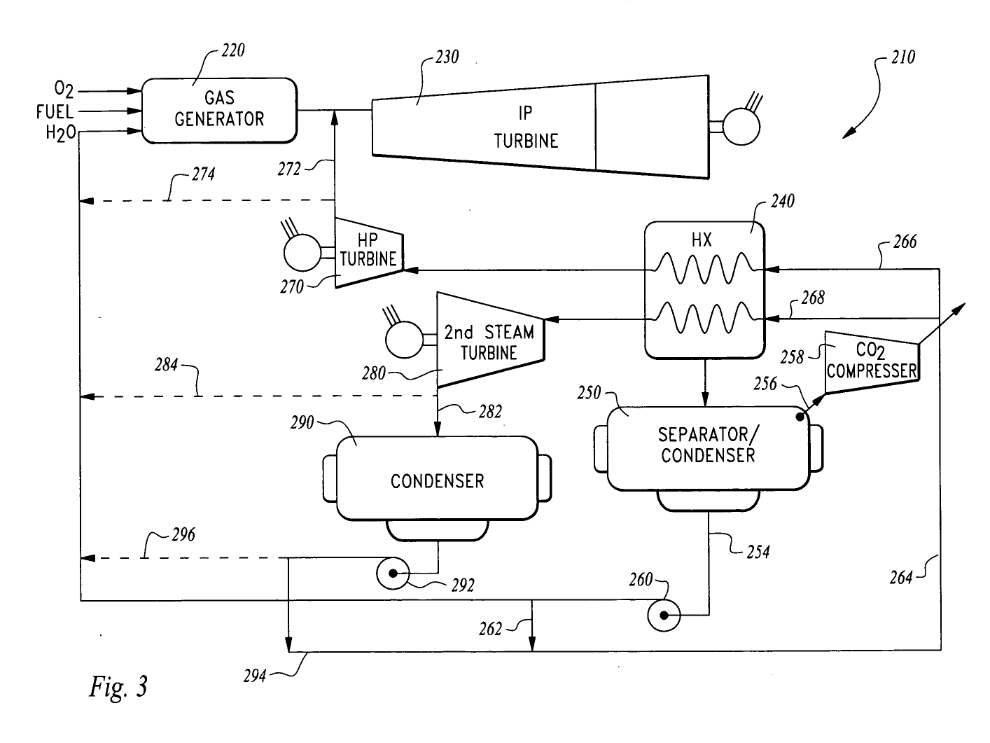

With particular reference to FIG. 3, details of a third embodiment hybrid cycle 210 are described. This third embodiment hybrid cycle 210 is similar to the hybrid cycle 10 of the preferred embodiment (FIG. 1) except as particularly described herein. In particular, a gas generator 210 supplies a drive gas mixture of high temperature and intermediate pressure to an IP turbine 230 where power is outputted from the system. This drive gas mixture is then routed to a heat exchanger 240 (HX) where the drive gas mixture is cooled.

The drive gas mixture is then passed to a separator/condenser 250 where the drive gas mixture is separated into a primarily steam component and a primarily carbon dioxide component. The water is discharged through a liquid outlet 254 while the carbon dioxide is discharged from a gas outlet 256. A CO2 compressor 258 can be provided to pressurize the CO2 gas for further handling and optional sequestration from the atmosphere.

The water discharged from the liquid outlet 254 is then pressurized at pump 260 before being returned to the gas generator 220. Such a primary pathway for the water between the pump 260 and the gas generator 220 is akin to the high pressure turbine bypass 90 of the basic hybrid cycle 10 (FIG. 1). In this second embodiment hybrid cycle 210, at least a portion of the water pressurized by the pump 260 is routed along path 262 to a high pressure line 264, with typically additional pumping to high pressure before passing along the line 266 or 268 into the heat exchanger 240 where heating of the high pressure water and boiling into gaseous steam takes place. Line 266 feeds the high pressure turbine 270 which then returns the steam along line 272 between the gas generator 220 and the IP turbine 230 for mixture with the drive gas mixture downstream of the gas generator 220 at a drive gas junction. Optionally, this HP turbine 270 could supply water/steam along line 274 back to an inlet of the gas generator 220. This HP turbine 270 is generally akin to the HP turbine 70 of the basic hybrid cycle 10 (FIG. 1).

The line 268 preferably passes through the heat exchanger 240 and then feeds a second steam turbine 280. The line 268 could be separate from the line 266 either before or after passing through the heat exchanger 240. The second steam turbine 280 outputs power from the cycle 210 and then routes steam along line 282 to a condenser 290. This pure steam condenser 290 condenses the steam into water and then pumps the steam at pump 292 to a higher pressure. The water can then be returned to the gas generator 220, such as along line 296 or the pressurized water can be routed along line 294 back to the high pressure line 264 and back to the heat exchanger 240 for routing through either the high pressure turbine 270 or the second steam turbine 280.

The third embodiment hybrid cycle 210 illustrates how multiple turbines 270, 280 or other expanders can be driven by substantially pure steam according to one embodiment of the hybrid cycle of this invention. In other embodiments, such as that depicted in FIG. 2 with the second embodiment hybrid cycle 110, multiple turbines or other expanders are driven by the drive gas mixture of steam and carbon dioxide, with only a single turbine driven by pure steam. In a most basic form of this invention, at least one turbine or other expander is driven by a drive gas mixture of steam and carbon dioxide and at least one turbine or other expander is driven by substantially pure steam, with all of the heat supplied to the system through as few as one gas generator, but optionally also with reheaters that combust additional oxygen and hydrocarbon fuel.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted. When “water” is referred to it can be either gaseous water (“steam”) or liquid water or a mixture of both. When “steam” is referred to it includes at least some gaseous water. When “water/steam” is referred to it can be either gaseous water or liquid water or a mixture of both.

What is claimed is:

1. An oxy-fuel combustion power generation system, comprising in combination:
a steam turbine adapted to expand a substantially pure water working fluid;
a drive gas turbine adapted to expand a drive gas mixture of at least steam and CO2;
a drive gas generator upstream from said drive gas turbine, said drive gas generator adapted to combust a hydrocarbon fuel with oxygen to produce the drive gas mixture including steam and carbon dioxide;
said steam turbine having an output for water located upstream of said drive gas turbine with said output of water forming at least a portion of the water in said drive gas mixture entering said drive gas turbine; and
a heat exchanger adapted to transfer heat from the drive gas mixture downstream of the drive gas turbine, said heat exchanger adapted to transfer heat into the water working fluid upstream of said steam turbine.

2. The system of claim 1 wherein said steam turbine output for water is located upstream of a water inlet of said drive gas generator.

3. The system of claim 1 wherein said steam turbine output for water is located upstream of a drive gas junction interposed on a drive gas line between said drive gas generator and said drive gas turbine, said junction passing at least a portion of the water from said steam turbine output to said drive gas turbine without passing through said drive gas generator.

4. The system of claim 1 wherein a condenser is located downstream from said heat exchanger, said condenser adapted to receive the drive gas mixture downstream of said heat exchanger, said condenser having a gaseous outlet for gases including primarily carbon dioxide and a liquid outlet for liquids including primarily water, said liquid outlet located upstream of said heat exchanger and upstream of said steam turbine.

5. The system of claim 4 wherein said gas outlet of said condenser is coupled to a compressor for compressing the gases from the drive gas mixture, including primarily carbon dioxide, to an elevated pressure, such as to facilitate storage or transport.

6. The system of claim 4 wherein said liquid outlet of said condenser is coupled to a steam turbine bypass, said steam turbine bypass adapted to route at least a portion of water from said liquid outlet of said condenser to a location upstream of said drive gas turbine, without passing through said steam turbine.

7. The system of claim 1 wherein said system includes a second steam turbine, said second steam turbine adapted to receive steam from a discharge of said heat exchanger, said second steam turbine having a substantially pure water condenser located downstream therefrom.

8. The system of claim 1 wherein a second drive gas turbine is located downstream from a low pressure discharge of said heat exchanger, said second drive gas turbine adapted to expand the drive gas mixture downstream from said low pressure discharge of said heat exchanger; and
a feedwater heater located downstream from said second drive gas turbine, said feedwater heater adapted to transfer heat from the drive gas mixture downstream from said second drive gas turbine to water upstream from said heat exchanger and upstream from said steam turbine.

9. A hybrid oxy-fuel combustion power process, including the steps of:
combusting a hydrocarbon fuel with oxygen to produce a drive gas mixture of at least steam and carbon dioxide;
expanding the drive gas mixture to output power;
routing the drive gas mixture through a heat exchanger after said expanding step;
cooling the drive gas mixture within the heat exchanger;
heating high pressure water with heat from the heat exchanger;
expanding the water to further output power; and
adding at least a portion of the water to the drive gas mixture after said step of expanding the water.

10. The process of claim 9 wherein said adding step includes uniting the water adjacent where the hydrocarbon fuel and the oxygen are combusted together to form the drive gas mixture during said combusting step.

11. The process of claim 9 wherein said adding step includes uniting the water with the drive gas mixture after said combusting step and before said step of expanding the drive gas mixture.

12. The process of claim 9 including the further step of separating the drive gas mixture after said cooling step into a primarily water stream and a primarily carbon dioxide stream.

13. The process of claim 12 wherein said separating step includes the step of condensing water portions of the drive gas mixture while maintaining carbon dioxide portions of the drive gas mixture as a gas.

14. The process of claim 12 including the further step of pumping water that was separated by said separating step to a higher pressure and providing this higher pressure water as at least a portion of the high pressure water of said heating step.

15. The process of claim 14 including the further steps of further expanding the drive gas mixture after said cooling step; and
further cooling the drive gas mixture after said further expanding step by transfer of heat to the higher pressure water of said pumping step before said higher pressure water is heated by said heating step.

16. An oxygen and hydrocarbon fuel combustion power generation system, comprising in combination:
a gas generator receiving oxygen from a source of primarily oxygen and hydrocarbon fuel from a source of primarily hydrocarbon fuel, said gas generator adapted to combust the oxygen and hydrocarbon fuel to produce a drive gas including gaseous water and carbon dioxide;
a drive gas expander located downstream from said gas generator, said drive gas expander adapted to expand the drive gas and output power;
a heat exchanger having a low pressure intake downstream from said drive gas expander, said heat exchanger adapted to transfer heat out of said drive gas mixture;
a separator downstream from said heat exchanger, said separator adapted to separate at least a portion of the water from at least a portion of the carbon dioxide within the drive gas mixture;
at least a portion of the water downstream from the separator routed to a high pressure intake of said heat exchanger, said heat exchanger adapted to heat the water entering said heat exchanger at said high pressure intake with heat from said drive gas mixture entering said heat exchanger at said low pressure intake;
a water expander downstream from said high pressure intake of said heat exchanger, said water expander adapted to expand the water and output power; and
at least a portion of the water downstream from the water expander routed to join with the drive gas mixture upstream of said drive gas expander.

17. The system of claim 16 wherein said system includes a means to return the water downstream from the water expander to said gas generator, said gas generator including a water inlet, said gas generator adapted to mix water from said water inlet with the drive gas mixture produced within said gas generator.

18. The system of claim 16 wherein said system includes a means to return at least a portion of the water downstream from the water expander to a drive junction to mix the water with the drive gas mixture between said gas generator and said drive gas expander.

19. The system of claim 16 wherein a second drive gas expander is located downstream from said low pressure intake of said heat exchanger, said second drive gas expander adapted to expand the drive gas mixture and output power.

20. The system of claim 19 wherein a feedwater heater is located downstream from said second drive gas expander and upstream of said separator, said feedwater heater adapted to cool the drive gas mixture and heat the water upstream of said high pressure intake of said heat exchanger.

21. The system of claim 16 wherein a bypass is adapted to route at least a portion of the water downstream of said separator to said gas generator without passing through said heat exchanger or said water expander.

22. The system of claim 16 wherein said separator includes a condenser having a liquid outlet for primarily water and a gas outlet for primarily carbon dioxide, said heat exchanger including at least two high pressure intakes for water, each of said high pressure intakes at least partially fed by water downstream from said separator, a first of said two high pressure intakes leading to said water expander and another of said at least two high pressure water intakes adapted to feed a second water expander separate from said water expander, said second steam turbine upstream of a steam condenser, said steam condenser having a liquid water outlet adapted to return at least a portion of water within said liquid water outlet back to said water discharged from said drive gas separator.
